(19) United States
(12) Patent Application Publication
(10) Pub. No.: US 2026/0219505 A1
(43) Pub. Date: Jul. 30, 2026

(54) WAVEGUIDES FOR DISPLAYS CONSTRUCTED FROM A COMBINATION OF FLAT AND CURVED SURFACES USING PLURAL INCOUPLERS

(71) Applicant: GOOGLE LLC, Mountain View, CA (US)

(72) Inventors: Daniel Adema, Kitchener (CA); Timothy Paul Bodiya, Knoxville, TN (US); Shreyas Potnis, Kitchener (CA)

(21) Appl. No.: 19/150,302

(22) PCT Filed: Feb. 22, 2024
(86) PCT No.: PCT/US2024/016886

§ 371 Date: Jul. 23, 2025

Related U.S. Application Data
(60) Provisional application No. 63/447,720, filed on Feb. 23, 2023.

(51) Int. Cl. G02B 27/01; G02B 6/34

(52) U.S. Cl. CPC G02B 27/0172; G02B 6/34; G02B 2027/011; G02B 2027/013; G02B 2027/0132; G02B 2027/0178

(57) ABSTRACT

Waveguides for displays constructed from a combination of flat and curved surfaces using plural incouplers include additional incouplers incorporated into a waveguide spaced from one another at precise angles, e.g., that match or correspond to grating angles associated with the waveguides, allowing the injection of light in multiple locations to the same grating structure while still maintaining k-space closure and thus preventing unintended refraction or distortion. Regions immediately surrounding incouplers and outcouplers in the waveguide include flat surfaces, while regions between the incouplers and outcouplers-include one or more curved surfaces.

### BACKGROUND

In head-mounted displays (HMDs), light from an image source is coupled into a lightguide substrate, generally referred to as a waveguide, by an optical input coupling element, such as an in-coupling grating (i.e., an “input coupler” or “incoupler”), which can be formed on a surface, or multiple surfaces, of the substrate or disposed within the substrate. Once the light beams have been coupled into the waveguide, the light beams are “guided” through the substrate, typically by multiple instances of total internal reflection (TIR) or by a coated surface(s). The guided light beams are then directed out of the waveguide by an output optical coupling (i.e., an “output coupler” or “outcoupler”), which can also take the form of an optical grating. The output coupler directs the light at an eye relief distance from the waveguide, forming an exit pupil within which a virtual image generated by the image source can be viewed by a user of the display device. In many instances, an exit pupil expander, which can also take the form of an optical grating, is arranged in an intermediate stage between the input coupler and output coupler to receive light that is coupled into the waveguide by the input coupler, expand the light, and redirect the light towards the output coupler.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example display system with a waveguide having a plurality of sections and incouplers in accordance with some embodiments.

FIG. 2 is a diagram illustrating a cross-section view of an example implementation of the waveguide of FIG. 1 in accordance with some embodiments.

FIG. 3 shows an example of light propagation within a waveguide implementing a one-dimensional grating in accordance with some embodiments.

FIG. 4 shows an example of light propagation within a waveguide implementing a two-dimensional grating in accordance with some embodiments.

FIG. 5 shows a waveguide embedded in a lens element of a display system comprising a plurality of sections and incouplers configured in accordance with some embodiments.

FIG. 6 shows a top view of a waveguide embedded in a lens element of a display system comprising a plurality of sections in accordance with a bi-ocular embodiment.

FIG. 7 shows a top view of a waveguide embedded in a lens element of a display system comprising a plurality of sections in accordance with a binocular embodiment.

FIG. 8 shows k-space and x-space diagrams for a conventional waveguide.

FIG. 9 shows k-space and x-space diagrams for one or more waveguides in a lens element of a display system comprising a plurality of incouplers configured in accordance with some embodiments.

FIGS. 10 and 11 show examples of how images sources and/or incouplers are distributed relative to a lens in accordance with the example of FIG. 9.

FIG. 12 shows k-space and x-space diagrams for one or more waveguides in a lens element of a display system comprising a plurality of incouplers configured in accordance with some embodiments.

FIG. 13 shows an example of how images sources and/or incouplers are distributed relative to a lens in accordance with the example of FIG. 12.

FIGS. 14-19 show k-space and x-space diagrams for one or more waveguides in a lens element of a display system comprising a plurality of incouplers configured in accordance with some embodiments.

FIG. 20 is a flow diagram illustrating an overall example method of fabricating an eyewear display in accordance with some embodiments.

### SUMMARY OF EMBODIMENTS

Embodiments described herein provide for waveguide configurations/architectures that overcome light deformation and artifact issues experienced by conventional curved waveguides. In an embodiment, an eyewear display device includes a light engine to project display light, a waveguide to direct the display light to an eye of a user, and a plurality of incouplers to couple the display light into the waveguide, where the waveguide includes angled gratings and the incouplers are disposed within or around the waveguide at a corresponding separation angle with respect to the angle of the gratings. In some embodiments, the waveguide comprises a curved region and a flat region. In some embodiments, the separation angle is one of approximately 60 degrees, approximately 120 degrees, and approximately 180 degrees.

In some embodiments, the plurality of incouplers produce overlapping field of view (FOV) regions in the waveguide. In some embodiments, the plurality of incouplers produce non-overlapping field of view (FOV) regions in the waveguide. In some embodiments, the plurality of incouplers produce two or more field of view (FOV) regions simultaneously in the waveguide. In some embodiments, each of the two or more FOV regions include images having a common resolution. In some embodiments, each of the two or more FOV regions include images having different resolutions. In some embodiments, the two or more FOV regions provide a primary and a secondary display. In some embodiments, the primary display FOV region displays text. In some embodiments, the plurality of incouplers produce two or more field of view (FOV) regions with binocular alignment. In some embodiments, the binocular alignment is applied to a FOV visible to both eyes of a user wearing the device.

In another embodiment, a waveguide includes a plurality of incouplers to couple display light into the waveguide, where the waveguide includes angled gratings and the incouplers are disposed within or around the waveguide at a corresponding separation angle with respect to the angle of the gratings. In some embodiments, the waveguide comprises a curved region and a flat region. In some embodiments, the separation angle is one of approximately 60 degrees, approximately 120 degrees, and approximately 180 degrees. In some embodiments, the plurality of incouplers produce overlapping field of view (FOV) regions in the waveguide. In some embodiments, the plurality of incouplers produce non-overlapping field of view (FOV) regions in the waveguide. In some embodiments, the plurality of incouplers produce two or more field of view (FOV) regions simultaneously in the waveguide. In some embodiments, each of the two or more FOV regions include images having different resolutions.

In another embodiment, a method includes projecting display light from an image source, coupling the display light into a waveguide via a plurality of incouplers, where the waveguide includes angled gratings and the incouplers are disposed within or around the waveguide at a corresponding separation angle with respect to the angle of the gratings, directing the display light through the waveguide via total internal reflection, and coupling the display light out of the waveguide via an outcoupler.

### DETAILED DESCRIPTION

Near-eye display devices such as eyewear display devices have multiple practical and leisure applications, but the development and adoption of wearable electronic display devices have been limited by the optics, aesthetics, manufacturing process, thickness, field of view, and prescription lens limitations of the optical systems used to implement existing display devices. For example, many conventional examples of eyewear display devices implement planar/flat waveguides in an attempt to achieve the maximum optical performance of the waveguide. However, embedding a planar waveguide into a curved lens typically results in a lens configuration that is very bulky and unnatural looking on a user's face when compared to the sleeker and more streamlined look of typical curved eyeglass and sunglass lenses. As such, curved waveguide architectures have been developed to, among other things, overcome the constraints placed on lens and frame design for eyewear display devices by planar waveguides. Curved waveguides conform better to the curvature of a lens when compared to planar waveguides and allow for thinner lenses to be implemented within an eyewear display device. However, the non-parallel or non-flat surfaces of a curved waveguide tend to propagate light at different angles, thereby reducing the optical performance of the waveguide. For example, the display information represented by the light can be deformed, and artifacts, such as ghosting, can be introduced into the displayed images.

Accordingly, described herein are example waveguide configurations/architectures that overcome the light deformation and artifact issues experienced by conventional curved waveguides. As described in greater detail below, a waveguide is embedded within a curved lens, such as an ophthalmic lens, of an eyewear display device or other near-eye display device according to the waveguide configurations described herein. The waveguide includes an input coupler, an exit pupil expander, and an output coupler. In a first configuration, the waveguide comprises a plurality of planar/flat piecewise sections. As used herein, “planar” and “flat” sections refer to sections of the waveguide that are substantially non-curved and straight.

A first piecewise section of the waveguide is situated between the input coupler and the exit pupil expander and comprises an angled configuration. For example, the first piecewise section comprises a first sub-section and a second sub-section that are angled relative to each other. In another example, the first piecewise section comprises at least one section that is angled with respect to another piecewise section of the waveguide situated before the input coupler. Angling the first piecewise section of the waveguide allows the first piecewise section of the waveguide to better conform to the curvature of the lens and further allows the light rays to bend as a result of the light rays passing through two flat surfaces at different angles.

A second piecewise section of the waveguide situated between the exit pupil expander and the output coupler comprises a flat configuration. Stated differently, the angle of the second piecewise section of the waveguide does not vary between the exit pupil expander and the output coupler. A third piecewise section of the waveguide situated after the output coupler comprises a flat or angled configuration. For example, the third piecewise section comprises a first sub-section and a second sub-section that are angled relative to each other. In another example, the third piecewise section comprises at least one section that is angled with respect to the second piecewise section. In yet another example, the third piecewise section comprises a flat configuration such that the angle along the third piecewise section does not vary. It should be understood that, in at least some embodiments, the first waveguide configuration comprises one or more piecewise sections situated before the input coupler that are flat or angled. It should be further understood that the first waveguide configuration can include additional piecewise sections, wherein one or more of the piecewise sections of the waveguide can include multiple sub-sections.

In a second configuration, the waveguide is comprised of a plurality of piecewise sections wherein one or more piecewise sections are curved, and at least one of the piecewise sections is flat. For example, a first piecewise section situated between the input coupler and the exit pupil expander comprises a curved configuration. Here, a “curved” configuration refers to a non-flat configuration that bends in a smooth continuous way without sharp angles compared to an “angled” configuration, which has two substantially straight sections of the waveguide that meet at a common point. Similar to the first waveguide configuration, curving the first piecewise section of the waveguide allows the waveguide to better conform to the curvature of the lens and further allows the light rays to bend as they travel within the volume defined by the curved surface.

In another example, the first piecewise section comprises at least one curved sub-section and at least one flat sub-section. The flat section or sub-section, in at least some embodiments, is angled with respect to another piecewise section of the waveguide situated before the input coupler. Similar to the first waveguide configuration, a second piecewise section of the waveguide situated between the exit pupil expander and the output coupler comprises a flat configuration. Stated differently, the angle of the second piecewise section of the waveguide does not vary between the exit pupil expander and the output coupler. A third piecewise section of the waveguide situated after the output coupler comprises a curved, flat, or angled configuration. For example, the third piecewise section comprises a first sub-section and a second sub-section that are angled relative to each other.

In another example, the third piecewise section comprises at least one section that is angled with respect to the second piecewise section. In yet another example, the third piecewise section comprises a flat configuration such that the angle along the third piecewise section does not vary. It should be understood that, in at least some embodiments, the second waveguide configuration comprises one or more sections situated before the input coupler that are curved, flat, or angled. It should be further understood that the second waveguide configuration can include additional piecewise sections, wherein one or more of the piecewise sections of the waveguide can include multiple sub-sections.

The first piecewise section of the waveguide is angled or curved in the first and second configurations, respectively, whereas the second piecewise section is flat because any deformation caused during light travel between the input coupler and the exit pupil expander is common to all outcoupling locations of the output coupler. Therefore, a common correction can be applied to the display information for all exit pupils. In contrast, any deformations caused during light travel between the exit pupil expander and the output coupler are varied across outcoupling locations of the output coupler, and correction of the deformations is specific for each exit pupil. By implementing a second piecewise section between the exit pupil expander and the output coupler having a flat configuration, deformations in the light traveling in this waveguide area are reduced or eliminated. As such, the waveguide configurations described herein allow a waveguide to be embedded within a curved lens with reduced thickness compared to conventional planar waveguides and with increased optical performance compared to conventional curved waveguides.

It should be noted that, although some embodiments of the present disclosure are described and illustrated with reference to a particular example near-eye display system in the form of an eyewear display device, it will be appreciated that the apparatuses and techniques of the present disclosure are not limited to this particular example, but instead may be implemented in any of a variety of display systems using the guidelines provided herein.

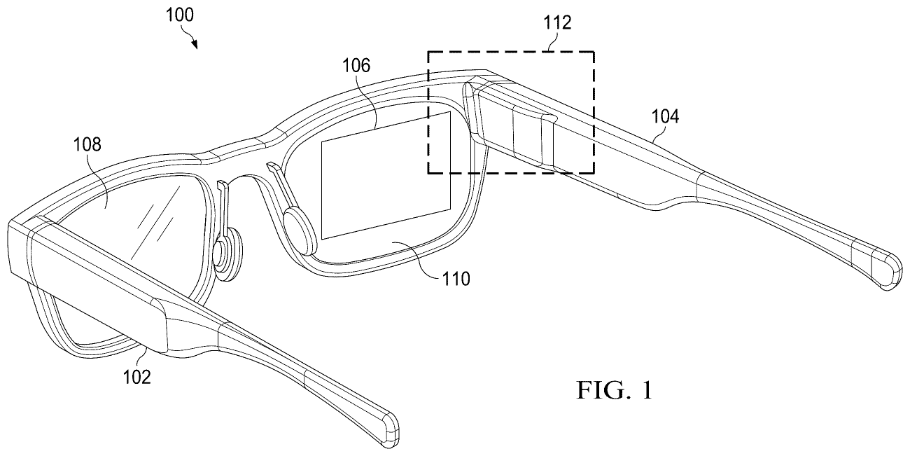

FIG. 1 illustrates an example display system 100 capable of implementing one or more of the waveguide configurations described herein. It should be understood that the waveguide configurations of one or more embodiments are not limited to display system 100 of FIG. 1 and apply to other display systems. In at least some embodiments, the display system 100 comprises a support structure 102 that includes an arm 104, which houses a light engine configured to project images toward the eye of a user such that the user perceives the projected images as being displayed in a field of view (FOV) area 106 of a display at one or both of lens elements 108, 110. In the depicted embodiment, the display system 100 is a near-eye display system in the form of an eyewear display device that includes the support structure 102 configured to be worn on the head of a user and has a general shape and appearance of an eyeglasses frame. The support structure 102 includes various components to facilitate the projection of such images toward the eye of the user, such as a light engine, an optical scanner, and a waveguide. In at least some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a Wireless Fidelity (WiFi) interface, and the like.

Further, in at least some embodiments, the support structure 102 includes one or more batteries or other portable power sources for supplying power to the electrical components of the display system 100. In at least some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments, the display system 100 may have a different shape and appearance from the eyeglasses frame depicted in FIG. 1.

One or both of the lens elements 108, 110 are used by the display system 100 to provide an augmented reality (AR) or a mixed reality (MR) display in which rendered graphical content is superimposed over or otherwise provided in conjunction with a real-world view as perceived by the user through the lens elements 108, 110. For example, display light used to form a perceptible image or series of images may be projected by a light engine of the display system 100 onto the eye of the user via a series of optical elements, such as a waveguide formed at least partially in the corresponding lens element, one or more scan mirrors, and one or more optical relays. Thus, one or both of the lens elements 108, 110 include at least a portion of a waveguide that routes display light received by an input coupler, or multiple input couplers, of the waveguide to an output coupler of the waveguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In at least some embodiments, the light engine is a matrix-based projector, a digital light processing-based projector, a scanning laser projector, or any combination of a modulative light source such as a laser or one or more light-emitting diodes (LEDs) and a dynamic reflector mechanism such as one or more dynamic scanners or digital light processors. The light engine, in at least some embodiments, includes multiple micro-LEDs. The light engine is communicatively coupled to the controller and a non-transitory processor-readable storage medium or memory storing processor-executable instructions and other data that, when executed by the controller, cause the controller to control the operation of the light engine. In at least some embodiments, the controller controls a scan area size and scan area location for the light engine and is communicatively coupled to a processor (not shown) that generates content to be displayed at the display system 100. The projector scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

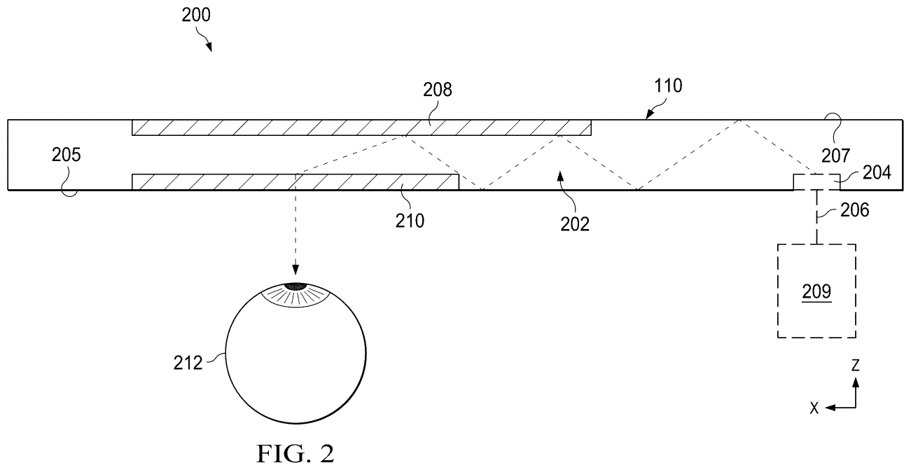

FIG. 2 depicts a cross-section view 200 of an implementation of a lens element 110 of a display system such as the display system 100 of FIG. 1. Note that for purposes of illustration, at least some dimensions in the Z direction are exaggerated for improved visibility of the represented aspects. In this example implementation, a waveguide 202, which may form a portion of the lens element 110 of FIG. 1, implements diffractive optical structures in a region 208 on the opposite side of the waveguide 202 as diffractive optical structures of a region 210. In particular, the diffractive optical structures of an incoupler 204 are implemented on an eye-facing side 205 of the lens element 110. Likewise, the diffractive optical structures of region 210 (which provide outcoupler functionality) are implemented at the eye-facing side 205. Further in the illustrated implementation, the diffractive optical structures of region 208 (which provide EPE functionality) are implemented at a world-facing side 207 of the lens element 110 that is opposite the eye-facing side 205. Thus, under this approach, display light 206 from a light source 209 including components capable of pixel shifting a time-division multiplexed display to produce an increased perceived display resolution is incoupled to the waveguide 202 via the incoupler 204, and propagated (through total internal reflection in this example) toward the region 208, whereupon the diffractive optical structures of the region 208 diffract the incident display light for exit pupil expansion purposes, and the resulting light is propagated to the diffractive optical structures of the region 210, which output the display light toward a user's eye 212. In other implementations, the positions of regions 208 and 210 may be reversed, with the diffractive optical structures of region 210 formed on the world-facing side 207 and the diffractive optical structures of region 208 formed on the eye-facing side 205, however, this may result in the regions 208 and 210 having different positions, dimensions, and shapes, and also may require diffractive optical structures in each region to have different characteristics.

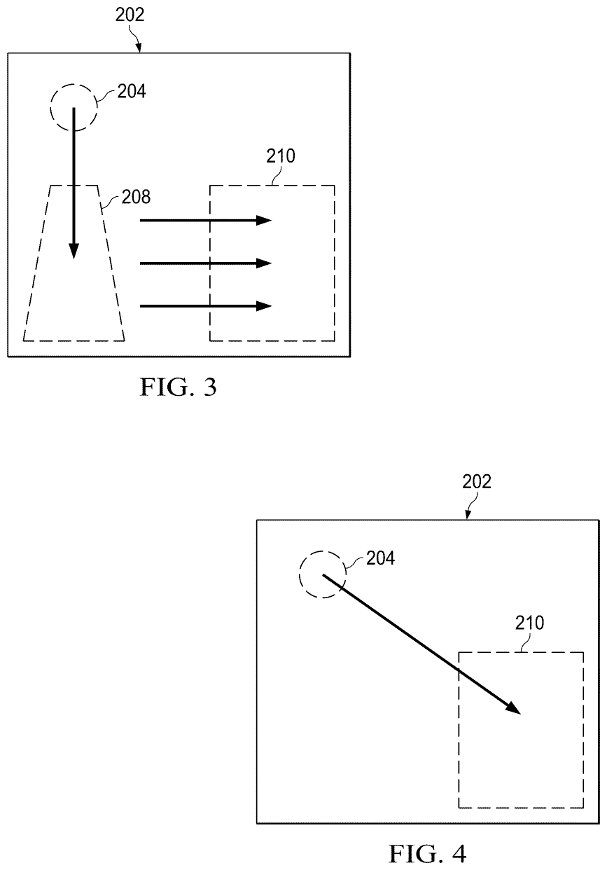

FIG. 3 shows an example of light propagation within the waveguide 202 of FIG. 2 when one-dimensional (1D) gratings are implemented in accordance with some embodiments. As shown, light received via the incoupler 204 is directed into the region 208 and then routed to the region 210 to be output (e.g., toward the eye 212 of the user). In some embodiments, region 208 expands one or more dimensions of the eyebox of a display system (e.g., the display system 100 of FIG. 1) that includes the light source 209 (e.g., with respect to what the dimensions of the eyebox of the display would be without the region 208). In some embodiments, the incoupler 204 and the region 208 each include respective 1D diffraction gratings (i.e., diffraction gratings that extend along one dimension), which diffract incident light in a particular direction depending on the angle of incidence of the incident light and the structural aspects of the diffraction gratings. It should be understood that FIG. 3 shows a substantially ideal case in which the incoupler 204 directs light straight down (with respect to the presently illustrated view), and the region 208 directs light to the right (with respect to the presently illustrated view) in a second direction that is perpendicular to the first direction. While not shown in the present example, it should be understood that, in some embodiments, the first direction in which the incoupler 204 directs light is slightly or substantially diagonal.

In at least some embodiments, the region 208 and the region 210 are separated into or onto separate sections of the waveguide 202. For example, the incoupler 204 and the region 208 are located in or on a first section, and the region 210 is located in or on a second section, where a planar direction of the first section is substantially parallel to a planar direction of the second section. In some embodiments, the incoupler 204 and the region 208 are located in or on a first substrate, and the region 210 is located in or on a second substrate, where the first substrate and the second substrate are arranged adjacent to one another in the manners described herein.

The waveguide 202, in at least some embodiments, includes multiple substrates with the region 208 located in or on a first substrate and the region 210 located in or on a second substrate that is separate from and adjacent to the first substrate. In some embodiments, a partition element is placed between the first substrate and the second substrate. For example, the partition element is an airgap (or gas-filled gap), a low-index refractive material layer, a polarizing beam splitter layer, or any combination thereof. In at least some embodiments, the partition element includes additional elements or an opening to direct light from the first substrate to the second substrate.

FIG. 4 shows another example of light propagation within the waveguide 202 of FIG. 2 when two-dimensional gratings (2D) are implemented in accordance with some embodiments. As shown, light received via the incoupler 204 is routed to the region 210 to be output (e.g., toward the eye 212 of the user). In the example shown in FIG. 4, the region 208 is not implemented by the waveguide 202 or is combined with the region 210. If the region 208 is combined with the region 210, the region 208 expands one or more dimensions of the eyebox of the display system as described above. In this example, the region 210 includes a 2D diffraction grating(s) (i.e., a diffraction grating(s) that extends along two dimensions), which diffracts incident light in a particular direction depending on the angle of incidence of the incident light and the structural aspects of the diffraction gratings.

As described above, implementing entirely flat waveguides in curved lenses generally necessitates the use of thicker lenses, which is undesirable from a design and aesthetic perspective, and implementing entirely curved waveguides in curved lenses increases the likelihood of display information being deformed or artifacts being introduced into displayed images. As such, the waveguide 202 implements one or more configurations/architectures that overcome the design and aesthetic issues of entirely flat waveguides and the light deformation and artifact issues caused by conventional curved waveguides.

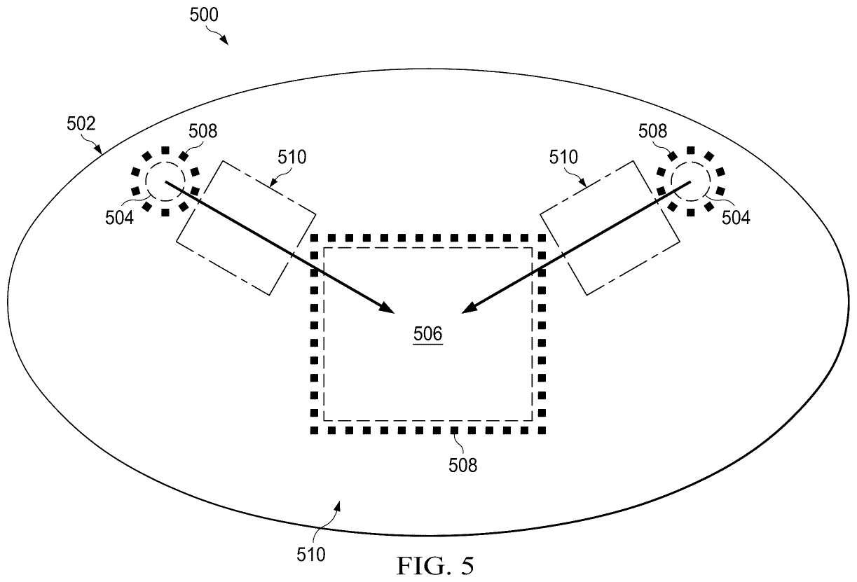

FIG. 5 shows a front view 500 of a waveguide 502 embedded in a lens element of a display system, such as the display system 100 of FIG. 1, comprising a plurality of sections and incouplers configured in accordance with some embodiments. As shown, in some embodiments, the waveguide 502 comprises a plurality of incouplers 504 and at least one outcoupler 506. In this example, regions 508 immediately surrounding the incouplers 504 and outcoupler 506 in the waveguide 502 include flat or substantially flat surfaces, while regions of curvature 510 between and/or otherwise outside of the incouplers 504 and outcoupler 506 in the waveguide 502 include one or more curved surfaces or regions. In some embodiments, display light projected into the one or more incouplers 504 includes compensation for any distortions caused by the regions of curvature 510. In other words, in some embodiments, a light source such as the light source 209 of FIG. 2 and/or one or more associated lenses or other optical elements, such as one or more gratings, applies a distortion to the display light to compensate for distortion caused by regions of curvature 510 through which display light passes. In some embodiments, the incouplers 504 are located at various locations in or around the glasses or lens, such as in or adjacent to a temple arm, the brow, and/or the nose bridge. In some embodiments, the waveguide 502 uses a similar or identical 2D grating structure as in a single-incoupler implementation.

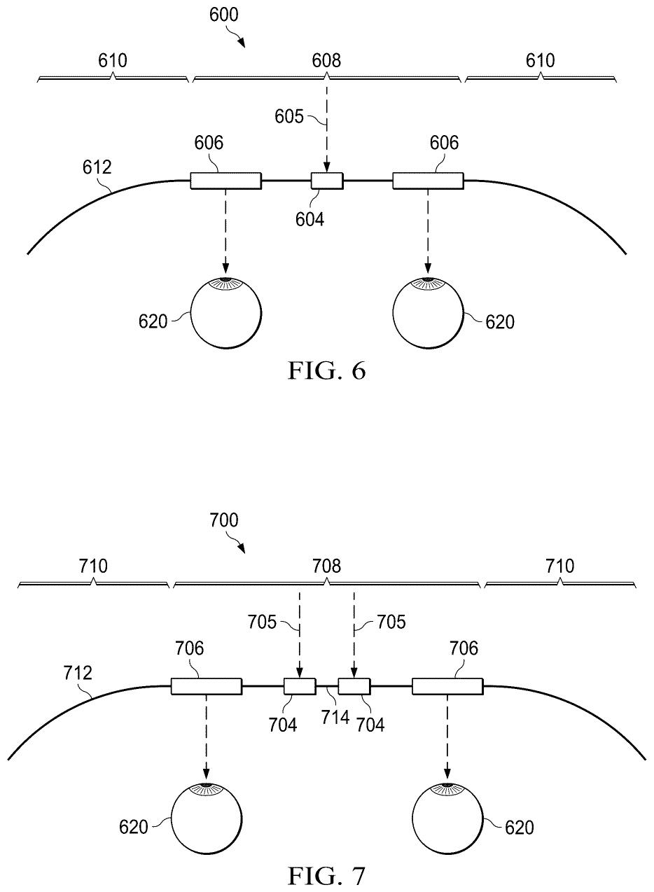

FIG. 6 shows a top view 600 of a waveguide embedded in a lens element of a display system, such as the display system 100 of FIG. 1, comprising a plurality of sections in accordance with a bi-ocular embodiment. In this example, one incoupler 604 routes display light 605 to two outcouplers 606 in a single substrate 612, or stack of substrates, that extends across both eyes 620 of a user. A region 608 between the incoupler 604 and outcouplers 606 in the lens/substrate 612 includes a substantially flat surface while regions 610, outside of the flat region 608, include curved surfaces.

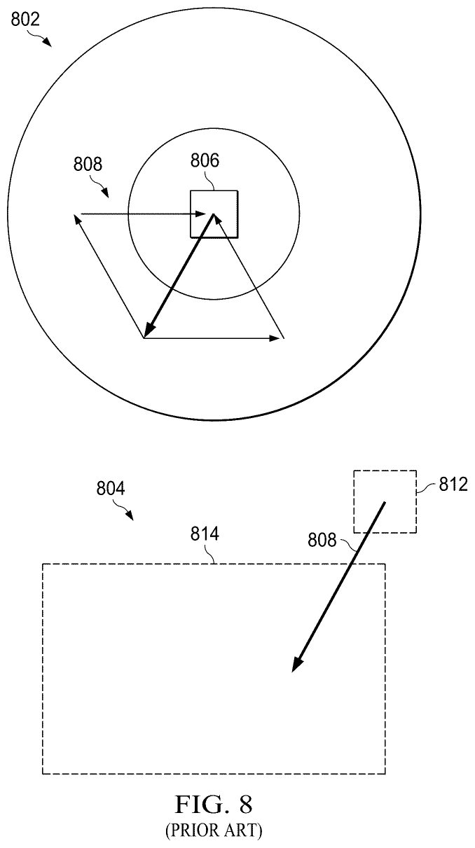

FIG. 7 shows a top view 700 of a waveguide embedded in a lens element of a display system, such as the display system 100 of FIG. 1, comprising a plurality of sections in accordance with a binocular embodiment. In this example, display light 705 is projected into two distinct incouplers 704, which route light to two outcouplers 706 in a single substrate, or stack of substrates, that extends across both eyes, enabling a binocular display with a separate image displayed for each eye. Similar to the example of FIG. 6, a region 708 between the incouplers 704 and outcouplers 706 in the lens/substrate 712 includes a substantially flat surface while regions 710, outside of flat region 708, include curved surfaces. Notably, although not explicitly shown in FIG. 7, in some embodiments, a region 714 between the incouplers 704 includes a curved surface.

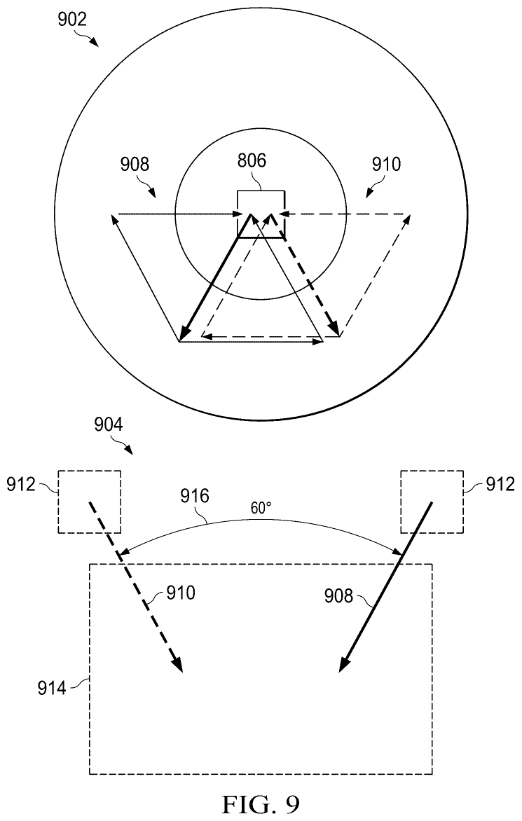

FIG. 8 shows k-space 802 and x-space 804 diagrams for a conventional waveguide. K-space diagrams, also known as k-vector or k-domain diagrams, indicate ratios of angles in a waveguide, while x-space diagrams indicate spatial relationships between portions of a waveguide, such as an incoupler and outcoupler. As shown in FIG. 8, a central square 806 in the k-space diagram 802 indicates the location of an incoupler and an outcoupler, while arrows 808 indicate potential paths light can take through the waveguide while passing between the incoupler and the outcoupler. As shown in FIG. 8, substantially all light entering the waveguide at the incoupler leaves the waveguide at the outcoupler due to the proper angular alignment of the incoupler, the outcoupler, and the waveguide. With regard to the x-space diagram 804 of FIG. 8, a small, dashed square 812 indicates an incoupler propagating the display light 808 down and across a larger rectangular outcoupler 814.

Although the conventional waveguide of FIG. 8 is usable for providing display light to a user, etendue is limited at the incoupler and a light source intended to be projected into an incoupler may have an exit pupil too large to efficiently couple to the incoupler. One solution to this issue is to use a smaller exit pupil for the light source, but this would result in substantial dimming of the viewed image due to the loss of light associated with reducing the size of the exit pupil of the light source.

FIG. 9 shows k-space 902 and x-space 904 diagrams for one or more waveguides in a lens element of a display system, such as the display system 100 of FIG. 1, comprising a plurality of incouplers configured in accordance with some embodiments. In order to resolve the issues of conventional waveguides, including limited brightness and limited coupling efficiency between incouplers and light source exit pupils, in some embodiments, additional incouplers are incorporated into the waveguide (or a second waveguide in the lens) spaced from one another at precise angles, e.g., that match or correspond to one or more grating angles in the incoupler, the outcoupler, and/or the waveguide (i.e., the incouplers are disposed within or around the eyewear display device, the lens element(s), or the waveguide(s) at a corresponding separation angle with respect to the angle of the gratings). This allows the injection of light from multiple locations to the same grating structure while maintaining k-space closure, thus preventing unintended refraction or distortion.

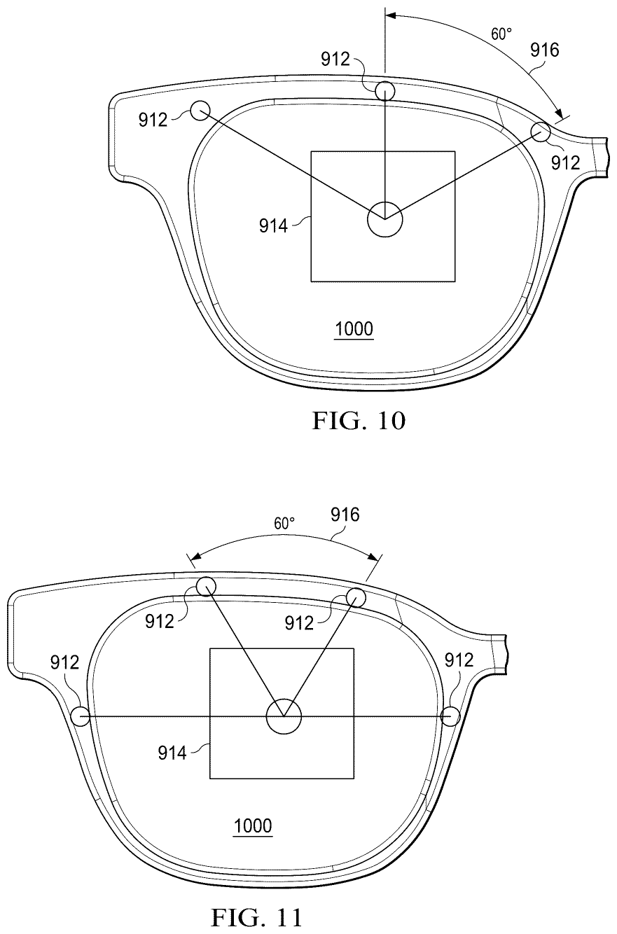

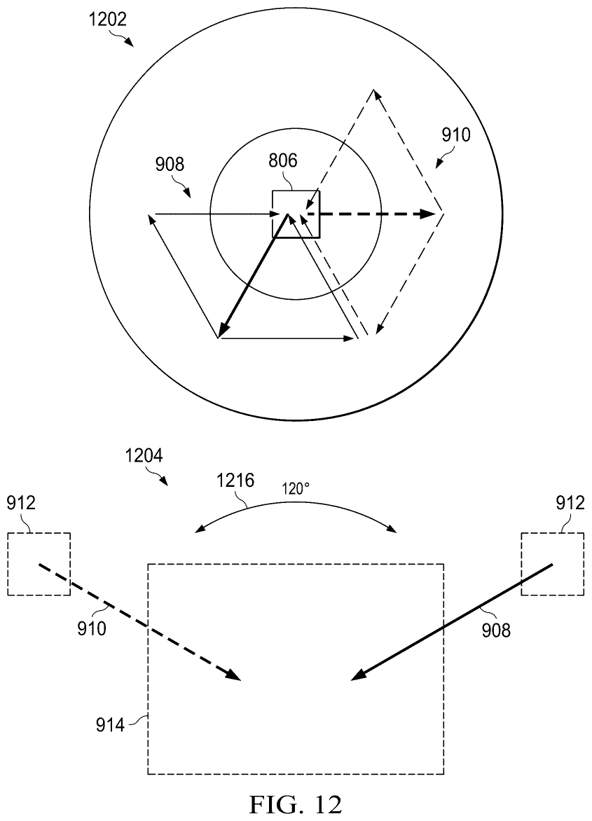

For example, as shown in FIG. 9, by providing such a separation angle 916 between the light sources and/or incouplers, the input display light 908, 910 follows separate paths but all arrives at the general vicinity of the outcoupler (or outcouplers) 914. Accordingly, in some embodiments, as shown in the x-space diagram 904 of FIG. 9, two physical incoupler locations indicated by dashed squares 912 provide display light 908, 910 from two or more separate light sources to a single outcoupler 914 or group of outcouplers collocated with an eyebox of a lens or other display. Thus, two light sources can provide light to a single eyebox of a lens or other display without undesirable refractions or distortions, as the light paths still form closed paths in k-space (as shown in the k-space diagram 902 of FIG. 9). Although FIG. 9 indicates a separation angle of approximately 60 degrees between the light sources and/or incouplers, in some embodiments, other angles, such as approximately 120 degrees and approximately 180 degrees, separate the light sources and/or incouplers. Notably, these increments produce equilateral triangles in the k-space diagrams, as shown in, e.g., FIGS. 9 and 12. FIGS. 10 and 11 show examples of how image sources and/or incouplers 912 are distributable relative to a lens element 1000, such as lens elements 108, 110 of display system 100 of FIG. 1, in accordance with the example of FIG. 9. For example, in FIG. 10, three incouplers 912 are spaced at separation angles 916 of 60 degrees around the lens element 1000, while in FIG. 11, four incouplers 912 are spaced at separation angles 916 of 60 degrees. In general, any number of incouplers and light sources may be implemented and spaced apart by appropriate separation angles in a display system, such as the display system 100 of FIG. 1, in order to implement aspects of the present disclosure.

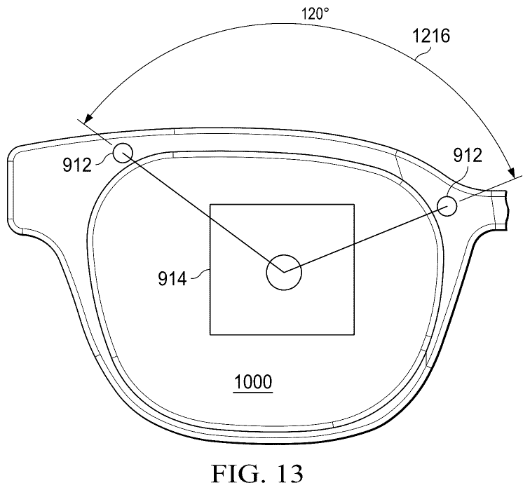

FIG. 12 shows k-space 1202 and x-space 1204 diagrams for one or more waveguides in a lens element of a display system, such as the display system 100 of FIG. 1, comprising a plurality of incouplers configured in accordance with some embodiments. In this example, a separation angle 1216 of 120 degrees determines the locations for the light sources and/or incouplers 912. FIG. 13 shows an example of how light sources and/or incouplers 912 are distributable relative to a lens element 1000, such as lens elements 108, 110 of display system 100 of FIG. 1, in accordance with the example of FIG. 12. As shown in the example of FIG. 13, two incouplers 912 are spaced at a separation angle 1216 of 120 degrees around a perimeter of the lens element 1000.

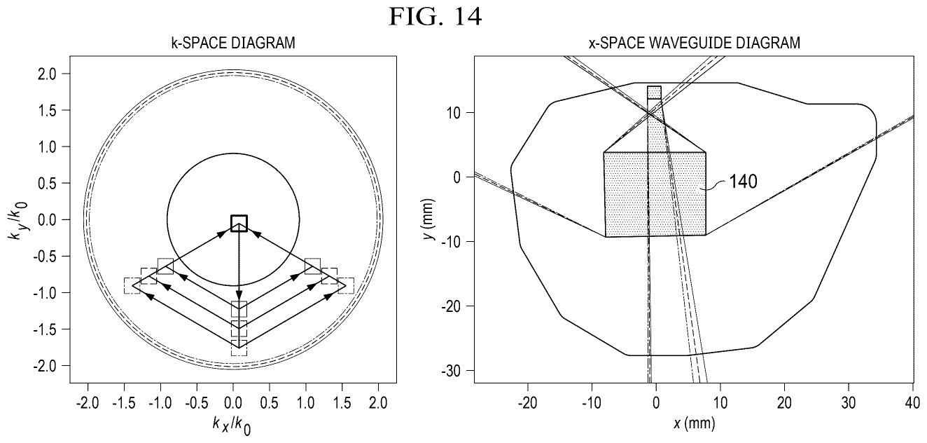

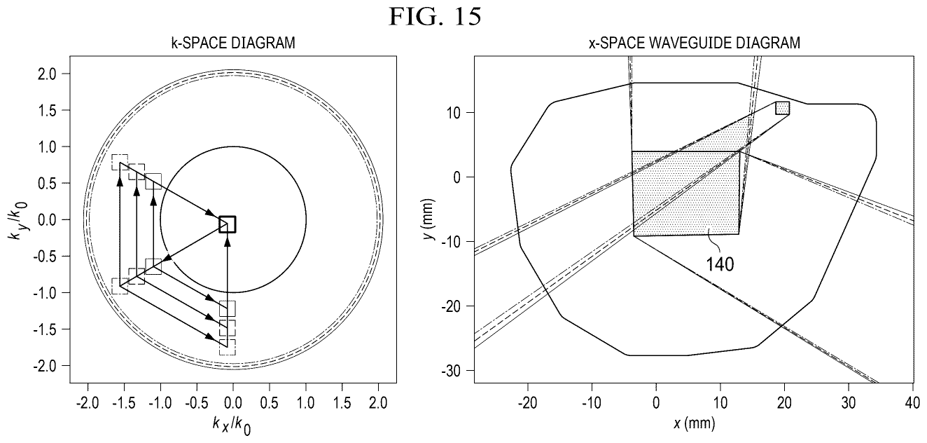

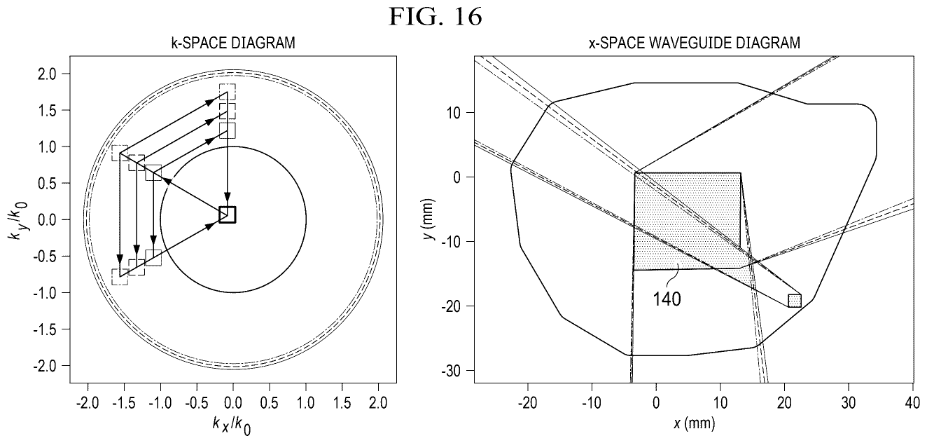

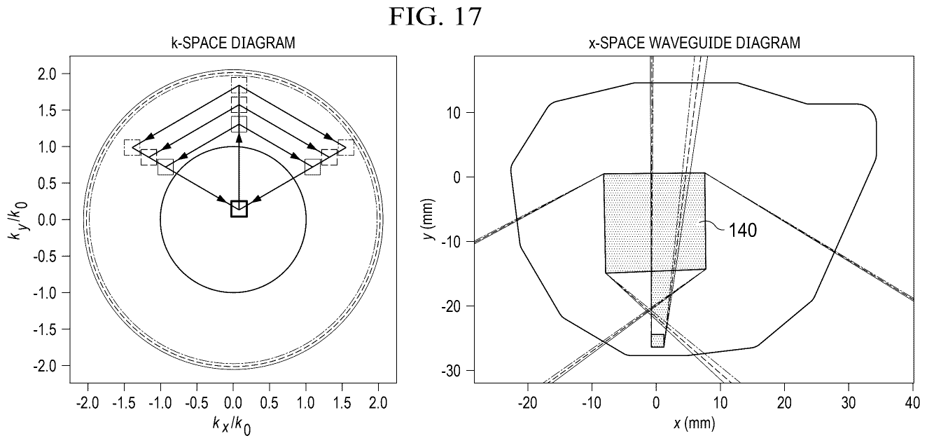

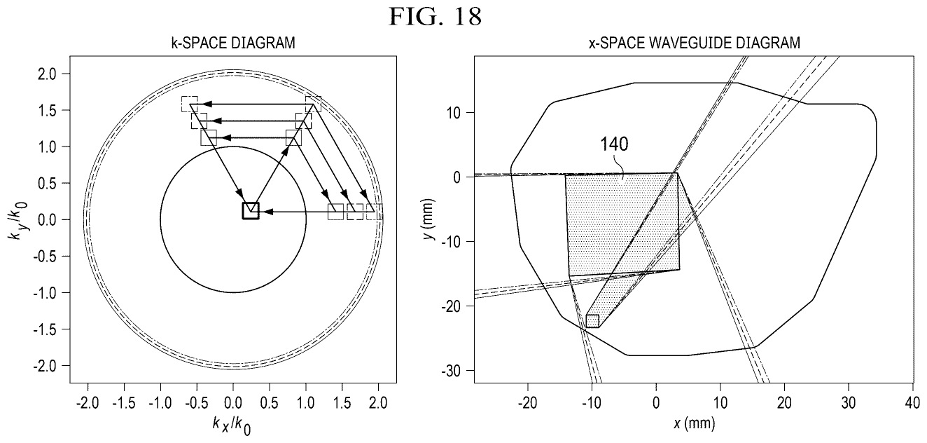

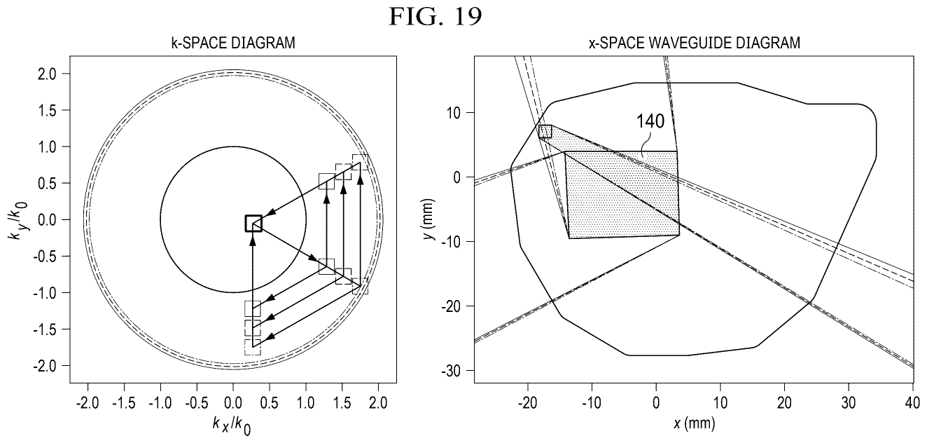

FIGS. 14-19 show k-space and x-space diagrams for one or more waveguides in a lens element of a display system, such as the display system 100 of FIG. 1, comprising a plurality of incouplers configured in accordance with some embodiments. Each of FIGS. 14-19 illustrate k-space and x-space diagrams for separate incouplers of a plurality of incouplers for a single lens. As shown in each of FIGS. 14-19 and illustrated by the shaded areas in the x-space diagrams, each incoupler produces a slightly different FOV regions 140 or viewable areas for display light transmitted through a waveguide in a lens element. In some embodiments, overlapping or non-overlapping FOV regions, which may be each be produced by separate light sources and/or incouplers, are utilized in a single lens. In some embodiments, two or more FOV regions are produced simultaneously. In some embodiments, the FOV regions include images having a common resolution or different resolutions, e.g., as a result of separate light sources and/or incouplers providing common or different resolutions.

For example, in some embodiments, a first region associated with a first incoupler or set of incouplers is aligned with an outcoupler and/or provides a high resolution display, which may include text or a primary display, while a second region associated with a second incoupler or set of incouplers may be slightly misaligned with an outcoupler and/or may provide a lower resolution display, which may include auxiliary or secondary displays, such as a turn indicator (e.g., an arrow) for use with a navigation display or a directional indicator (e.g., an arrow or blinking light) to indicate a point of interest the user may view by turning their head in accordance with the directional indicator. In some embodiments, the FOV regions are aligned in a binocular implementation. In some embodiments, binocular alignment is applied to an entire FOV or only to a central region of the lens. For example, in some embodiments, an entire virtual or combined FOV is visible to both eyes (e.g., 100% binocular overlap), while in other embodiments only a central portion of the FOV is seen in both eyes while edge regions of the FOV are visible only to a single eye (e.g., partial binocular overlap).

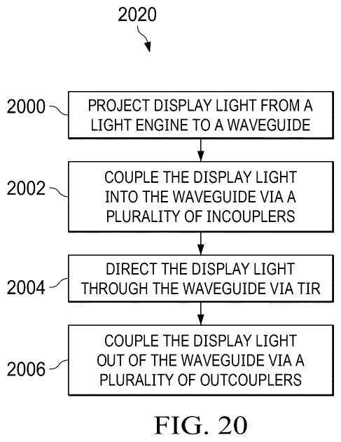

FIG. 20 illustrates, in flow chart form, an overview of one example method 2020 of providing display light in an eyewear display system, such as the display system 100 of FIG. 1, in accordance with one or more embodiments. At block 2000, the display projects display light from one or more light engines, such as light source 209 of FIG. 2, to a waveguide, such as waveguide 202 of FIG. 2. At block 2002, the display light is coupled into the waveguide via a plurality of incouplers, such as incoupler 204 of FIG. 2, incouplers 504 of FIG. 5, incouplers 604 of FIG. 6, incouplers 704 of FIG. 7, or incouplers 912 of FIG. 9. In some embodiments, the waveguide comprises gratings having an angle, and the incouplers are disposed within or around the waveguide at a corresponding separation angle with respect to the angle of the gratings. At block 2004, the display light is directed through the waveguide via total internal reflection. At block 2006, the display light is coupled out of the waveguide via one or more outcouplers, such as outcoupler 210 of FIG. 2, outcoupler 506 of FIG. 5, outcouplers 606 of FIG. 6, outcouplers 706 of FIG. 7, or outcoupler 914 of FIG. 9, and toward a user's eye or eyes.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An eyewear display device comprising:
a light engine to project display light;
a waveguide comprising gratings having an angle to direct the display light to an eye of a user; and
a plurality of incouplers disposed within or around the waveguide at a corresponding separation angle with respect to the angle of the gratings to couple the display light into the waveguide.

2. The eyewear display device of claim 1, wherein the waveguide comprises a curved region and a flat region.

3. The eyewear display device of claim 1, wherein the separation angle is one of approximately 60 degrees, approximately 120 degrees, and approximately 180 degrees.

4. The eyewear display device of claim 1, wherein the plurality of incouplers produce overlapping field of view (FOV) regions in the waveguide.

5. The eyewear display device of claim 1, wherein the plurality of incouplers produce non-overlapping field of view (FOV) regions in the waveguide.

6. The eyewear display device of claim 1, wherein the plurality of incouplers produce two or more field of view (FOV) regions simultaneously in the waveguide.

7. The eyewear display device of claim 6, wherein each of the two or more FOV regions include images having a common resolution.

8. The eyewear display device of claim 6, wherein each of the two or more FOV regions include images having different resolutions.

9. The eyewear display device of claim 8, wherein the two or more FOV regions provide a primary and a secondary display.

10. The eyewear display device of claim 9, wherein the primary display FOV region displays text.

11. The eyewear display device of claim 1, wherein the plurality of incouplers produce two or more field of view (FOV) regions with binocular alignment.

12. The eyewear display device of claim 11, wherein the binocular alignment is applied to a FOV visible to both eyes of a user wearing the device.

13. A waveguide, comprising:
a plurality of incouplers to couple display light into the waveguide, wherein the waveguide comprises gratings having an angle, and the incouplers are disposed within or around the waveguide at a corresponding separation angle with respect to the angle of the gratings.

14. The waveguide of claim 13, wherein the waveguide comprises a curved region and a flat region.

15. The waveguide of claim 13, wherein the separation angle is one of approximately 60 degrees, approximately 120 degrees, and approximately 180 degrees.

16. The waveguide of claim 13, wherein the plurality of incouplers produce overlapping field of view (FOV) regions in the waveguide.

17. The waveguide of claim 13, wherein the plurality of incouplers produce non-overlapping field of view (FOV) regions in the waveguide.

18. The waveguide of claim 13, wherein the plurality of incouplers produce two or more field of view (FOV) regions simultaneously in the waveguide.

19. The waveguide of claim 18, wherein each of the two or more FOV regions include images having different resolutions.

20. A method comprising:
projecting display light from an image source;
coupling the display light into a waveguide via a plurality of incouplers, wherein the waveguide comprises gratings having an angle, and the incouplers are disposed within or around the waveguide at a corresponding separation angle with respect to the angle of the gratings;
directing the display light through the waveguide via total internal reflection; and
coupling the display light out of the waveguide via an outcoupler.
